(19) United States
(12) Patent Application Publication
(10) Pub. No.: US 2007/0279408 A1
(43) Pub. Date: Dec. 6, 2007

(54) Method and system for data transmission and recovery

(75) Inventors: Dong Zheng, San Jose, CA (US); Paul Ta, Fremont, CA (US); Roger Levinson, Los Gatos, CA (US)

Correspondence Address: MACPHERSON KWOK CHEN & HEID LLP, 2033 GATEWAY PLACE, SUITE 400, SAN JOSE, CA, 95110, US

(73) Assignee: Intersil Corporation

(21) Appl. No.: 11/446,488

(22) Filed: Jun. 1, 2006

(51) Int. Cl. G09G 5/00; H04L 12/28

(52) U.S. Cl. 345/213; 370/395.62; 345/520

(57) ABSTRACT

Multiple data streams are distributed using conventional data cables and multiplexing circuits by taking advantage of a technique that allows reliable high speed transmission of digital data. In one example, a number of parallel data streams (e.g., video data streams) are serialized to allow them to be economically and reliably transmitted over conventional data cables (e.g., category 5 or category 6 twisted pair cables, and automotive data transmission cables) over long distance. The parallel data streams are recovered by deserializing from the transmitted signal using a data recovery technique that recovers a clocking signal from the transmitted signal. In another example, multiple data streams from multiple asynchronous sources are multiplexed to provide an input data stream to a display device. The multiple data stream may be provided through, for example, conventional connection cables (e.g., DVI, LEONI, CATS or CAT6 cables).

### BACKGROUND OF THE INVENTION

1. Field of the Invention

The present invention relates to high-speed data communications. In particular, the present invention relates to high-speed data recovery using a clock signal recovered from the transmitted signal. This invention enables transmitting video signals using low-cost cables.

2. Discussion of the Related Art

In recent years, digital signal processing techniques enable very high quality audio and video applications. High quality is achieved because digital signal processing allows signal levels to be defined to high precision using a sufficiently large number of data bits to represent the signal levels; at the same time, fidelity is preserved because of the noise immunity inherent in the digital data representation. In addition, signal degradation may be avoided using error detection and correction techniques. Thus, systems handling these applications invariable require a high data throughput. For example, under the Digital Visual Interface (DVI) standard, each color of a picture element (pixel) may be defined by a number of bits (e.g., 8 bits), with each bit being carried in a differential conductor. Thus, a typical video image lasting, for example, 1/30 of a second may comprise more than a million pixels. To make these systems available to the mass market consumers, the high data throughput has to be achieved in an inexpensive manner.

Digital data is often transmitted between components in a system in parallel over a multi-bit signal bus to achieve the high data throughput. When the components are not provided on the integrated circuit or a printed circuit board, the cost of parallel transmission between these components is high because of the number of conductors required in the connecting cable. Further, the rate at which the data bits may be transmitted is limited by the tolerable mismatch in signal delay between any two data bits on the signal bus. The cost of the cable becomes prohibitive for many applications when the components to be connected are expected to be separated by a significant distance. For example, a cable for carrying a SVGA signal for a 60 Hz LCD monitor would need to be operating at 30 MHz and would require more than two dozen conductors.

### SUMMARY OF THE INVENTION

The present invention takes advantage of a technique which allows reliable high speed transmission of digital video data to distribute multiple data streams using conventional data cables and multiplexing circuits.

According to one embodiment of the present invention, a number of parallel data streams (e.g., video data streams or video pixel signals) are serialized to allow them to be economically and reliably transmitted over long distance using conventional data cables (e.g., category 5 or category 6 twisted pair cables, or cables for automotive data communications, such as LEONI Dacar cable products popular for use in automotive data transmission applications). The parallel data streams are recovered by deserializing from the transmitted signal using a data recovery technique that recovers a clocking signal from the transmitted signal.

According to another embodiment of the present invention, multiple data streams from multiple asynchronous sources are multiplexed to provide an input data stream to a display device. The multiple data stream may be provided through, for example, conventional connection cables (e.g., DVI, LEONI, CAT5 or CAT6 cables).

The present invention is better understood upon consideration of the detailed description below in conjunction with the accompanying drawings.

### BRIEF DESCRIPTION OF THE DRAWINGS

FIG. 1 shows schematically serializer 100 and deserializer 150, according to one embodiment of the present invention.

FIG. 2 is a block diagram showing the major components of phase-locked loop circuit 200, which may be used to implement a phase-locked loop of deserializer 150.

FIG. 3 shows a circuit 300 suitable for use in a DVI application, according to a second embodiment of the present invention.

### DETAILED DESCRIPTION OF THE PREFERRED EMBODIMENTS

According to one embodiment of the present invention, digital video signals may be transmitted over long distance by (1) converting the digital video signals into a serial data stream (“serializing”) before transmission from a source component, (2) transmitting the serial signal over the distance in a cable with fewer conductors than would be required by the digital video signals, and (3) converting the serial signal back to the digital video signals (“deserializing”) upon receipt by the destination component. In this manner, the present invention avoids both the problem of parallel data bit synchronization and the high material cost of the connecting cable.

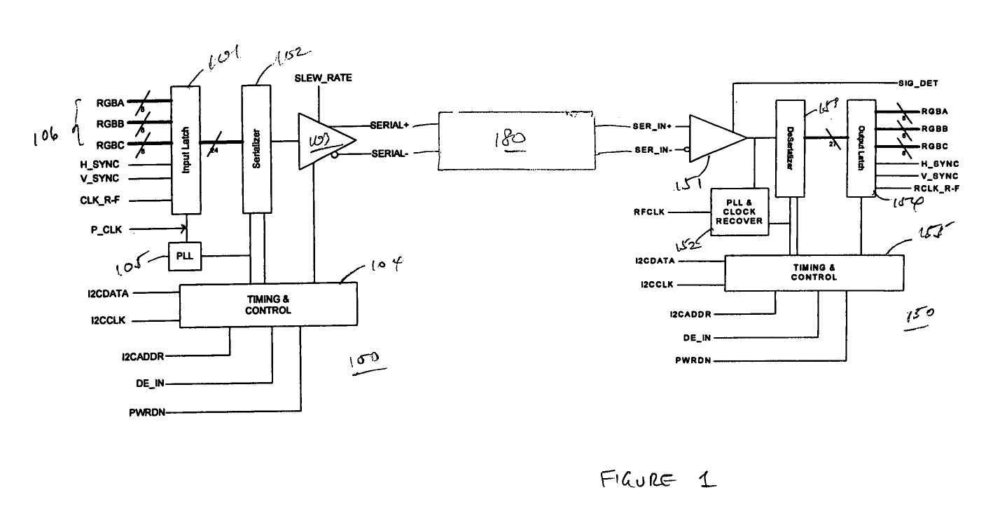

FIG. 1 shows schematically serializer 100 and deserializer 150, according to one embodiment of the present invention. Serializer 100 and deserializer 150 may be used, for example, to implement data communication between two video components under a suitable data standard (e.g., the DVI standard or the high definition multimedia interface or HDMI standard), or under a proprietary data format. In FIG. 1, for example, a single differential pair transmits data under a proprietary data format. As shown in FIG. 1, serializer 100 includes input latch 101 which receives twenty-four (24) single-ended digital signals from data bus 106, each signal implementing a bit in the 8-bit representations of the colors (e.g., red, green and blue; collectively, “color data”) in a 3-color component video system. In this embodiment, each signal may operate at a data rate of 30-50 Megabits per second (Mbps). In addition, input latch 101 also receives control signals h_sync, v_sync and CLK_R-F. The control signals h_sync and v_sync are control signals familiar to those skilled in video signals. Signal CLK_R-F specifies for input latch 101 whether the parallel data signal should be latched at a rising edge or a falling edge of the reference clock signal. The control signals may also be used to provide synchronization patterns for deserializer 150. For example, when the control signal h_sync is asserted, serializer 100 provides the corresponding predetermined bit pattern for h_sync in the output signal to assist in synchronizing word and pixel boundaries at deserializer 150. Further, a synchronization bit pattern may be inserted prior to transmitting a block of color data.

Based on input reference signal P_CLK and a predetermined serializing ratio, phase-locked loop 105 generates a reference clock signal which is used to latch input signals into latch 101 and to output its contents, and another reference clock signal to clock multiplexer/serializer 102. Multiplexer/serializer 102 selects one of the parallel signals of latch 101 to be driven by encoder/transmitter 103 as output differential signal (SERIAL+, SERIAL−) onto the conductors of a connecting cable 180. Output differential signal (SERIAL+, SERIAL−) may be coded, for example, according to the 8b/10b coding scheme familiar to those skilled in the 10GBASE Ethernet technology. In this embodiment, as both the coding scheme and the electrical characteristics of differential signal (SERIAL+, SERIAL−) conform to the 10GBASE Ethernet technology standard, a convention category 5 (CAT5) or category 6 (CAT6) twisted pairs cable or automotive data transmission cables (e.g., LEONI Dacar products) may be used as connection cable 180. Such a connection cable is known to provide signal integrity up to a distance of a hundred or more meters. Techniques such as transmitter pre-amphasis and receiver equalization allow the signal to be successfully transmitted over an even greater distance. In this embodiment, the data rate achieved on differential output signal (SERIAL+, SERIAL−) may be, for example, 1.5 gigabits per second (Gbps).

In FIG. 1, control circuit 104 controls the operation of serializer 100. As shown in FIG. 1, control circuit 104 may be itself controlled over an I²C bus (I²CADDR, I²CDATA, I²CCLK). Signal DE_IN informs serializer 100 whether color data or control signals should be output. Control signal PWRDN allows power management.

As shown in FIG. 1, the differential signal (SERIAL+, SERIAL−) is received into and decoded by decoding/receiver circuit 151. Phase-locked loop 152, which provides a recovery clock reference by multiplying the frequency of an input reference clock signal RECLK, recovers a clock signal from the output decoded data signal of decoder/receiver circuit 151. This recovered clock signal is used to clock deserializer/demultiplexer 158 to recover the 27 signals transmitted in differential signal (SERIAL+, SERIAL−). Because of the high data rate required in this application, a suitable scheme for robust data and clock recovery is used to implement phase-locked loop 152. One suitable circuit for clock and data recovery is disclosed by one of the present inventors in U.S. Pat. No. 6,931,089, entitled “Phase-locked Loop with Analog Phase Rotator,” filed on Aug. 21, 2001. The disclosure of the '089 patent is hereby incorporated by reference in its entirety to inform the clock and data recovery technique.

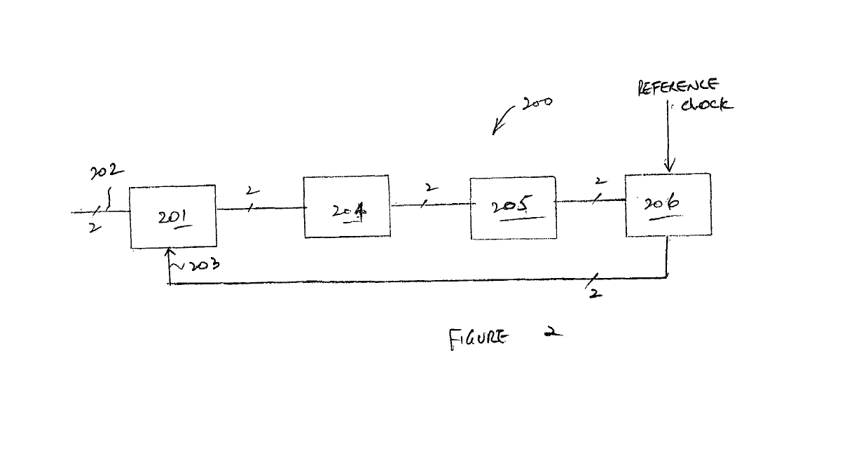

FIG. 2 is a block diagram showing the major components of phase-locked loop circuit 200 in accordance with the teachings of the '089 patent. As shown in FIG. 2, phase-locked loop circuit 200 includes phase-detector 201 receiving decoded differential data signal 202. Phase-detector 201 provides a phase-difference signal which indicates in the data signal a phase difference between the input data and the recovered differential clock signal at terminals 203. The recovered differential clock signal is generated by multiplier 206 based on an input reference clock signal. The phase-difference signal is optionally low-pass filtered by low-pass filter 204, which provides the phase-difference signal to analog rotator circuit 205. Analog rotator circuit 205 adjusts the phase of the data signal through multiplier circuit 206. A control signal from analog rotator circuit 205 adjusts the phase difference by changing the multiplier in multiplier circuit 206, thereby increasing or decreasing the frequency of recovered differential clock signal at terminals 203.

Returning to FIG. 1, latch 154 latches the deserialized signal at the output terminals of deserializer 153 and recovers the parallel data and control signals at the input data rate of serializer 100.

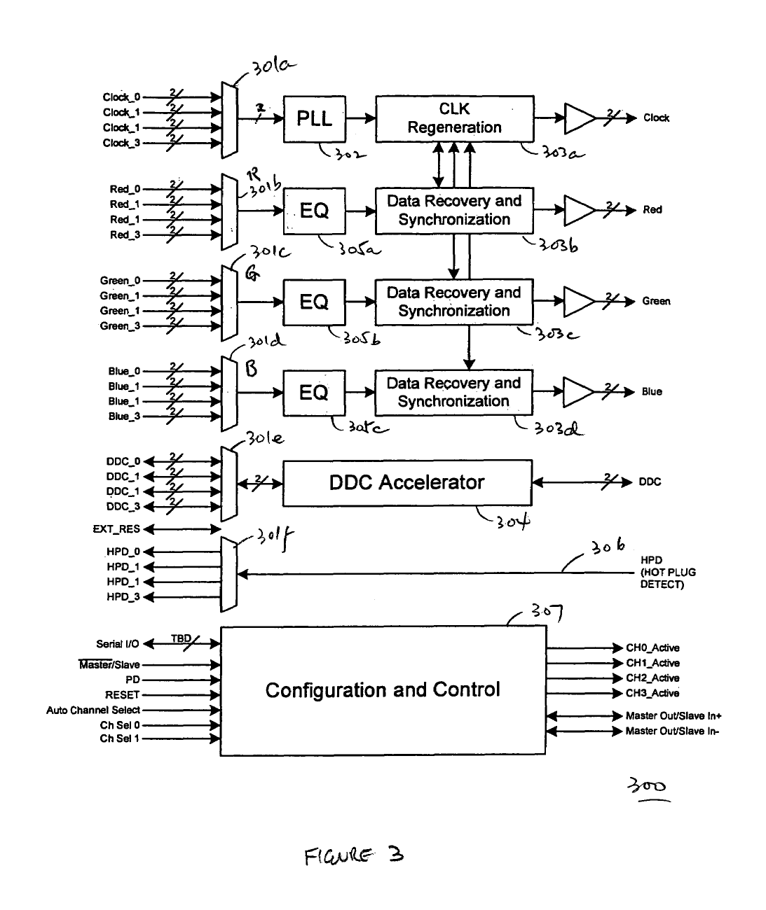

The present invention is applicable also to receiving high-speed digital data from multiple asynchronous sources. FIG. 3 shows a circuit 300 suitable for use in this application, according to a second embodiment of the present invention. As shown in FIG. 3, color data is received from 4 sources, with each source providing a clock signal and a differential data signal in each of the component colors (e.g., red green or blue) at corresponding input terminals of 4:1 multiplexers 301a, 301b, 301c and 301d. Multiplexers 401a, which receives the clock signals from the four sources, provides the clock signal from the selected source to phase-locked loop 302, which recover the clock signal using a clock multiplier phase-locked loop. The recovered clock can then be used to recover the differential component color signal from each of the signals selected by multiplexers 301b, 301c and 301d using, for example, the technique disclosed in the '089 patent incorporated by reference above. Note that, under this scheme, the clock signal of multiplexer 301 a is used in the receiver only as a frequency reference, the actual clocking of the recovered data signal (i.e., the color data signals) is extracted from each of the data signal itself. Consequently, the phase relationship between the transmitted clock signal and a data signal, or the phase relationships among transmitted data signals are irrelevant, thereby increasing the system's tolerance to transmission noise. Because the clock signal for clocking each data stream is recovered from the data stream itself, any phase relationship required of the transmitted clock and its associated data signals is significantly reduced, thus relaxing the signal integrity requirements on the connecting cables. Further, in addition to multiplexing multiple DVI signals, the present scheme also extends the distance over which signals can be transmitted using DVI cables, because the transmitted signals are re-clocked. FIG. 3 also represents multiplexing the signals from multiple DVI channels. Each DVI channel may arrive at the circuit of FIG. 3 through the same or different DVI cables, for example. Due to signal degradation in the multiplexing process, the clock and data recovery process shown in FIG. 3 is used to allow reliable data recovery. The analog rotator circuit disclosed in the '089 patent is suitable for this application. FIG. 3 therefore shows data recovery circuits 303a, 303b and 303c recovering the RGB data from 4 DVI channels.

The multiplexing circuit of FIG. 3 includes display data channel (DDC) data, which may be used in a KVM application, for example, to allow bi-directional identification between a video source and a display device receiving the output signals of circuit 300. In that application, a hot-plug detect (HPD) signal can be provided to alert the video sources when the display device comes on-line. In an automobile application, only a single differential pair is required for video data transmission.

The above detailed description is provided to illustrate the specific embodiments of the present invention and is not intended to be limiting. Numerous variations and modifications within the scope of the present invention are possible. The present invention is set forth in the following claims.

We claim:

1. A signal processing circuit for processing a plurality of digital signals, comprising:
a first interface for receiving one or more input signals encoding the digital signals;
a phase-locked loop coupled to the interface for recovering a clock signal from the input signals; and
a data recovery circuit receiving the clock signal and the input signals, wherein the data recovery circuit recovers the digital signals according to the timing in the clock signal.

2. A signal processing circuit as in Claim 1, wherein the digital signals comprise component color signals of a video image and wherein the signal processing circuit further comprises a second interface for providing the recovered digital signals to input terminals of a video display.

3. A signal processing circuit as in claim 2, wherein the second interface conforms to the DVI standard or the HDMI standard.

4. A signal processing circuit as in claim 1, wherein the phase-locked loop comprises:
a phase-detector receiving the input signal and the clock signal, the phase-detector providing a phase difference signal representative of a phase difference between the input signal and clock signal;
a multiplier circuit that, in response to a control signal, adjusts the phase of the clock signal; and
an analog rotator circuit that provides the control signal to achieve a desired phase in the clock signal relative to the input signal, in response to the phase difference signal.

5. A signal processing circuit as in claim 1, wherein the digital signals are serialized in one of the input signals.

6. A signal processing circuit as in claim 5, wherein the input signal is transmitted to the first interface over a connection cable.

7. A signal processing circuit as in claim 6, wherein the connecting cable is selected from the group consisting of category 5 twisted pair cables, category 6 twisted pair cables and LEONI cable assemblies.

8. A signal processing circuit as in claim 1, wherein the input signals comprise signals from multiple asynchronous sources.

9. A signal processing circuit as in claim 8, wherein the first interface comprises a plurality of multiplexers each receiving a plurality of input signals from the multiple asynchronous sources.

10. A signal processing circuit as in claim 9, wherein each multiplexer feeds into a separate data recovery channel.

11. A signal processing circuit as in claim 1, wherein the digital signals comprise a second clock signal which provides a reference signal in the signal processing circuit.

12. A signal processing circuit as in claim 1, wherein the digital signals comprise data and control signals.

13. A method for signal processing, comprising:
receiving at a first interface one or more input signals encoding the digital signals;
providing a phase-locked loop coupled to the interface for recovering a clock signal from the input signals; and
using the clock signal and the input signals to recover the digital signals according to the timing in the clock signal.

14. A method as in claim 13, wherein the digital signals comprise component color signals of a video image and wherein the method further comprises providing the recovered digital signal through a second interface to input terminals of a video display.

15. A method as in claim 14, wherein the second interface conforms to the DVI standard or the HDMI standard.

16. A method as in claim 13, wherein providing the phase-locked loop comprises:
receiving the input signal and the clock signal at a phase detector, the phase-detector providing a phase difference signal representative of a phase difference between the input signal and clock signal;
in response to the phase difference signal, providing a control signal from an analog rotator circuit aimed at achieving a desired phase in the clock signal relative to the input signal; and
in response to a control signal, adjusting a multiplier that controls the phase of the clock signal.

17. A method as in claim 12, wherein the digital signals are serialized in one of the input signals.

18. A method as in claim 17, wherein the input signal is transmitted to the first interface over a connection cable.

19. A method as in claim 18, wherein the connecting cable is selected from the group consisting of category 5 twisted pair cables, category 6 twisted pair cables and LEONI cable assemblies.

20. A method as in claim 12, wherein the input signals comprise signals from multiple asynchronous sources.

21. A method as in claim 20, wherein providing the first interface comprises providing a plurality of multiplexers each receiving a plurality of input signals from the multiple asynchronous sources.

22. A method as in claim 21, wherein each multiplexer feeds into a separate data recovery channel.

23. A method as in claim 12, wherein the digital signals comprise a second clock signal which provides a reference signal in the signal processing circuit.

24. A method as in claim 12, wherein the digital signals comprise data and control signals.
